(19) United States
(12) Patent Application Publication
(10) Pub. No.: US 2016/0356372 A1
(43) Pub. Date: Dec. 8, 2016

(54) DIFFERENTIAL ASSEMBLY WITH SINGLE WELD JOINT CONNECTING TWO-PIECE DIFFERENTIAL CASE AND RING GEAR

(71) Applicant: Magna Powertrain of America, Inc., Troy, MI (US)

(72) Inventor: John D. Zalewski, Lake Orion, MI (US)

(21) Appl. No.: 14/733,775

(22) Filed: Jun. 8, 2015

(51) Int. Cl. F16H 48/40

(52) U.S. Cl. CPC F16H 48/40

(57) ABSTRACT

A differential assembly is provided to include a two-piece differential case, a differential gearset disposed in a gearset chamber formed in the differential case, and a ring gear. An interlocking feature mechanically interconnects the first and second case members of the two-piece differential case and define a continuous differential case weldment surface. The ring gear is mounted on the differential case such that its ring gear weldment surface is aligned with the differential case weldment surface. A welded joint along the aligned weldment surfaces creates a weldment junction connecting the case members and the ring gear to each other.

### TECHNICAL FIELD OF THE INVENTION

The present disclosure relates generally to differential assemblies for use in motor vehicle drivelines. More particularly, the present disclosure relates to differential assemblies configured to permit use of a single weldment junction to rigidly interconnect the two case members of a two-piece differential case and a ring gear.

### BACKGROUND OF THE INVENTION

This section provides background information related to the present disclosure which is not necessarily prior art to the inventive concepts disclosed and claimed herein.

A conventional drive axle assembly typically includes an axle housing from which a pair of axleshaft extend to support a pair of wheels positioned on opposite sides of the motor vehicle. Drive torque generated by the vehicle's powertrain is delivered to the axle assembly via an input shaft. The input shaft drives a hypoid gearset for transmitting drive torque to a differential assembly having a differential gearset drivingly connected to the axleshafts. The hypoid gearset typically includes a pinion gear driven by the input shaft and which is meshed with a crown or ring gear which, in turn, is rigidly secured to a differential case of the differential assembly. The differential gearset is disposed within the differential case and includes at least one pair of pinion gears rotatably mounted on a pinion post or cross-pin fixed to the differential case, and a pair of side gears each being meshed with the at least one pair of pinion gears. Each side gear is also coupled to a corresponding one of the axleshafts such that driven rotation of the differential case via the hypoid gearset causes drive torque to be transmitted to the differential gearset in a manner permitting relative rotation between the axleshafts.

At one time, a majority of the differential cases were made as a one-piece iron casting. Iron castings have lower ductility and yield strength compared to most steels and, therefore, cast differential cases typically require thick wall dimensions which detrimentally impact weight and packaging and results in reduced powertrain efficiency. To address the shortcomings of cast differential cases, development has been directed to two-piece differential cases having a pair of case members made from higher strength steel using cold-forming processes. Examples of differential assemblies equipped with such two-piece differential cases are disclosed in U.S. Pat. Nos. 4,125,026; 6,045,479; 6,176,152; 6,945,898; and 7,261,664. In each of these configurations, the two case members of the differential case are initially connected together with a first weld seam and the ring gear is subsequently connected to the welded two-piece differential case using a second weld seam and/or bolts.

As a further advancement, efforts have been directed to development of differential assemblies configured to utilize a single weld seam to interconnect the two-piece differential case and the ring gear. For example, U.S. Publication No. US2009/0266198 and U.S. Pat. No. 8,444,522 each disclose a differential assembly having a first case member disposed between a radial flange portion of a second case member and a radial flange portion of the ring gear, with the weld seam only interconnecting the ring gear to the radial flange portion of the second case member. As a further alternative, U.S. Publication No. US2012/0325047 discloses a differential assembly having an “integral” end cap and ring gear component that is welded to a one-piece differential case.

In view of the above, there remains a continuing need to develop further improvements to differential assemblies and, in particular, to two-piece differential case arrangements which overcome the shortcomings of conventional single-piece and two-piece differential case arrangement and provide improvements in weight savings, packaging space requirements and reduced assembly complexity.

### SUMMARY OF THE INVENTION

This section provides a general summary of the disclosure and is not a comprehensive disclosure of its full scope or all of its aspects and features. The description and specific examples disclosed in this summary are not intended to limit the scope of the inventive concepts disclosed herein.

It is an aspect of the present disclosure to provide a differential assembly of the type adapted for use in motor vehicle driveline applications and which is equipped with a two-piece differential case and a ring gear that are interconnected to each other along a common weldment junction via a single weld seam.

It is another aspect of the present disclose to provide a two-piece differential case for use with a differential assembly, the two-piece differential case being defined by a first case member and a second case member that are mechanically interconnected via an interlocking feature. The interlocking feature establishes a differential case weldment surface that is configured to be aligned with a ring gear weldment surface for establishing the common weldment junction therebetween.

In accordance with these and other aspects of the present disclosure, a differential assembly is provided which includes a two-piece differential case, a differential gearset disposed within a gearset chamber formed within the differential case, and a ring gear. The two-piece differential case includes a first case member having first locking elements and a second case member having second locking elements that are interdigitated with the first locking elements to provide a mechanical interconnection between the first and second case members and which together establish a differential case weldment surface. The ring gear includes a rim segment which surrounds the mechanically interconnected first and second case members and defines a ring gear weldment surface that is configured to be aligned with the differential case weldment surface. A single seam of weld material is provided between and along the aligned weldment surfaces for rigidly securing the ring gear to both case members of the differential case as well as for rigidly securing the first case member to the second case member.

### DRAWINGS

The drawings described herein are for illustrative purposes only of selected embodiments and are not intended to limit the scope of the present disclosure. Accordingly, the inventive concepts associated with the present disclosure will be more readily understood by reference to the following description in combination with the accompanying drawings, where:

FIG. 1 is an isometric view of a differential assembly constructed in accordance with a first embodiment of the present disclosure;

FIG. 2 is an exploded isometric view illustrating the differential assembly of FIG. 1 to include a ring gear and a two-piece differential case;

FIG. 3 is another exploded isometric view, similar to FIG. 2, but illustrating elements of an interlocking feature provided between the first and second case members of the two-piece differential case in greater detail;

FIG. 4 is a sectional view taken generally through line A-A of FIG. 1 to better illustrate components of a differential gearset located within the two-piece differential case;

FIG. 5 is an isometric view of a differential assembly constructed in accordance with a second embodiment of the present disclosure;

FIG. 6 is an exploded isometric view illustrating the differential assembly of FIG. 5 to include a ring gear and a two-piece differential case;

FIG. 7 is another exploded isometric view, similar to FIG. 6, but illustrating elements of another interlocking feature provided between the first and second case members of the two-piece differential case in greater detail;

FIG. 8 is a sectional view taken generally through line B-B of FIG. 5 to better illustrate the components of a differential gearset located within the two-piece differential case; and

FIG. 9 is a diagram illustrating a method of assembling and welding the differential case components and the ring gear to manufacture the differential assembly of FIGS. 1-4 and the differential assembly of FIGS. 5-8.

Common reference numerals are used through the several figures to identify corresponding components.

### DESCRIPTION OF THE EXEMPLARY EMBODIMENTS

Example embodiments will now be described more fully with reference to the accompanying drawings. Each of the example embodiments is directed to a differential assembly. The example embodiments only are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

In general, the present disclosure is directed to one or more embodiments of a differential assembly of the type well suited for use in power transfer devices such as, for example, drive axles and transaxles, to transmit drive torque from the powertrain of a motor vehicle to a pair of ground-engaging wheels. The differential assemblies of the present disclosure each include a two-piece differential case, a differential gearset operably disposed between the differential case and a pair of axleshafts, and a ring gear adapted to be rigidly secured to the differential case. The two-piece differential case is configured to include first and second case members adapted to be mechanically interconnected via an interlocking arrangement in a manner to define a common differential case weldment surface. The ring gear is configured to engage an outer surface of at least one of the first and second case members and define a ring gear weldment surface that is adapted to be aligned with the differential case weldment surface. The ring gear is welded to the differential case by providing a weld seam along a weldment junction established by the aligned weldment surfaces. The specific interlocking arrangements disclosed herein each include a plurality of first locking elements formed on the first case member that are configured to be alternatively interleaved or interdigitated with a plurality of second locking elements formed on the second case member.

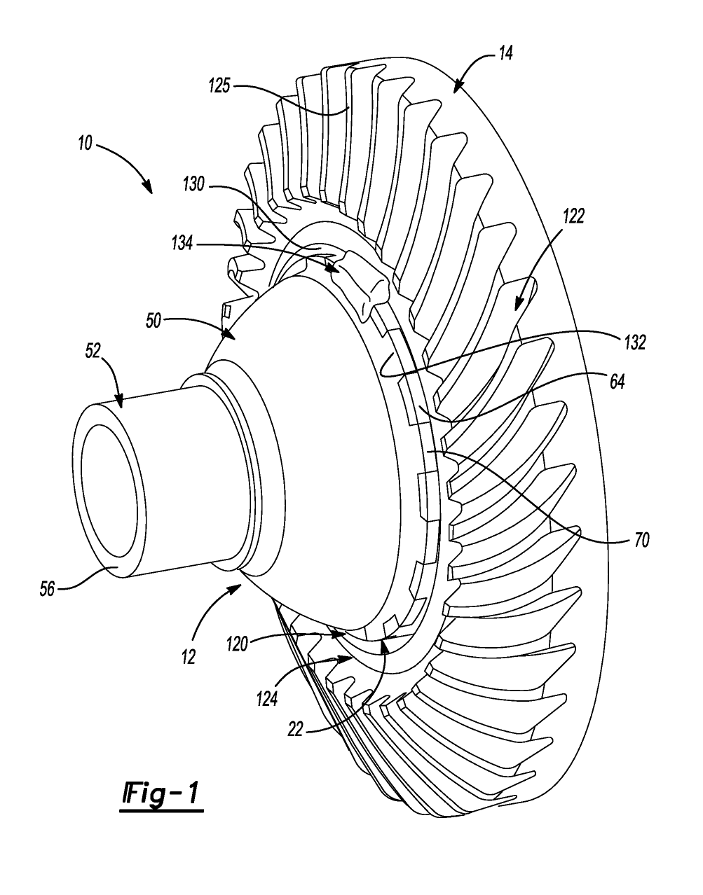

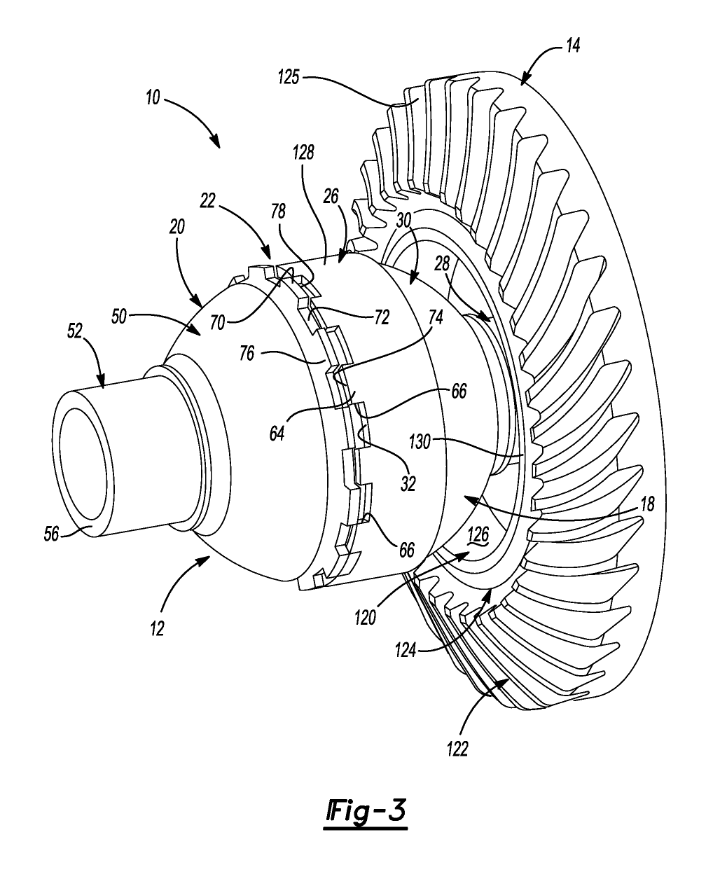

With particular reference to FIGS. 1 through 4 of the drawings, a first embodiment of a differential assembly 10 constructed in accordance with the present disclosure is generally shown to include a two-piece differential case 12, a ring gear 14, and a differential gearset 16. As will be detailed, differential gearset 16 is adapted to be installed with an internal gearset chamber formed within two-piece differential case 12 prior to ring gear 16 being secured to differential case 12. Two-piece differential case 12 generally includes a first case member 18, a second case member 20, and an interlocking arrangement or feature 22 configured to mechanically interconnect first and second case members 18 and 20 and establish a continuous differential case weldment surface 24.

First case member 18 is configured, in this non-limiting example, to include a larger diameter first cylindrical segment 26, a smaller diameter second cylindrical segment 28, and a semi-spherical segment 30 interconnecting first and second cylindrical segments 26 and 28. A first open end surface 32 is associated with first cylindrical segment 26 while a second open end surface 34 is associated with second cylindrical segment 28. First case member 18 is configured to define a portion of the gearset chamber including a pinion chamber 38 within first cylindrical segment 26, a first side gear chamber 40 within semi-spherical segment 30, and a first axleshaft chamber 42 within second cylindrical segment 28.

Second case member 20 is configured, in this non-limiting example, to include a semi-spherical segment 50 and a cylindrical segment 52. A first open end surface 54 is associated with semi-spherical segment 50 while a second open end surface 56 is associated with cylindrical segment 52. Second case member 20 also defines a portion of the gearset chamber including a second side gear chamber 58 formed within semi-spherical segment 50 and a second axleshaft chamber 60 formed within cylindrical segment 52. Cylindrical segment 28 of first case member 18 and cylindrical segment 52 of second case member 20 define a pair of laterally-spaced hub segments on which bearing assemblies (not shown) are mounted for supporting two-piece differential case 20 for rotation within an axle housing (not shown) in a manner known in the art.

Mechanical interlocking feature 22 is shown, in this first non-limiting embodiment, to include a plurality of axially-extending and circumferentially-spaced first locking elements, hereinafter referred to as fingers 64, and which extend outwardly from first open end surface 32 of first case member 18. A plurality of circumferentially-aligned first retention apertures, hereinafter referred to as slots 66, are also formed in first case member 18 between adjacent fingers 64. Interlocking feature 22 further includes a plurality of radially-extending and circumferentially-spaced second locking elements, hereinafter referred to as lugs 70, and which extend radially in a co-planar arrangement from first open end surface 54 of second case member 20. A plurality of circumferentially-aligned second retention apertures, hereinafter referred to as pockets 72, are also formed between adjacent lugs 70. As will be understood, each finger 64 is configured to be positioned within a corresponding one of pockets 72 while each lug 70 is concurrently configured to be positioned within a corresponding one of slots 66. In a preferred, but non-limiting embodiment of interlocking feature 22, terminal end surfaces 74 of fingers 64 are configured to be aligned with first face surfaces 76 of lugs 70 while second face surfaces 78 of lugs 70 are configured to be aligned with open end surface 32. Thus, upon mechanical interconnection, end surface 32 of first case member 18 is located in close proximity to end surface 54 of second case member 20. Additionally, the arcuate profile of the outer surface of axially-extending fingers 64 is configured to be aligned with the top edge surface of lugs 70 so as to define a continuous cylindrical interconnection between the interdigitated fingers 64 and lugs 70.

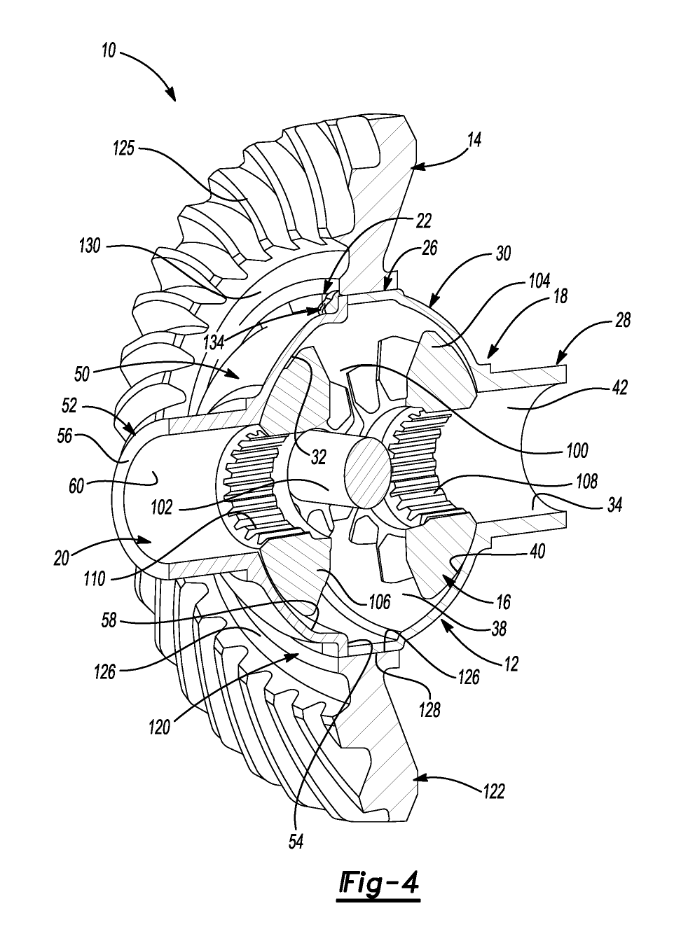

As best shown in FIG. 4, differential gearset 16 includes at least one pair of pinion gears 100 (only one shown), each pinion gear 100 being rotatably mounted on a pinion pin or cross-pin 102 that is fixed to first cylindrical segment 26 of first case member 18 for common rotation with two-piece differential case 12. Gearset 16 further includes a first side gear 104 and second side gear 106, each in constant mesh with pinion gears 100. Pinion gears 100 are generally aligned to rotate within pinion chamber 38 of first case member 18 while first side gear 104 is aligned to rotate within first side gear chamber 40 of first case member 18. Similarly, second side gear 106 is rotatably supported in second side gear chamber 58 of second case member 20. First side gear 104 includes internal spline teeth 108 provided for establishing a splined connection with external spline teeth (not shown) formed on a first axleshaft (not shown) that is rotatably supported in first axleshaft chamber 42 of first case member 18. Similarly, second side gear 106 includes internal spline teeth 110 provided for establishing a splined connection with external spline teeth (not shown) formed on a second axleshaft (not shown) that is rotatably supported in second axleshaft chamber 60 of second case member 20.

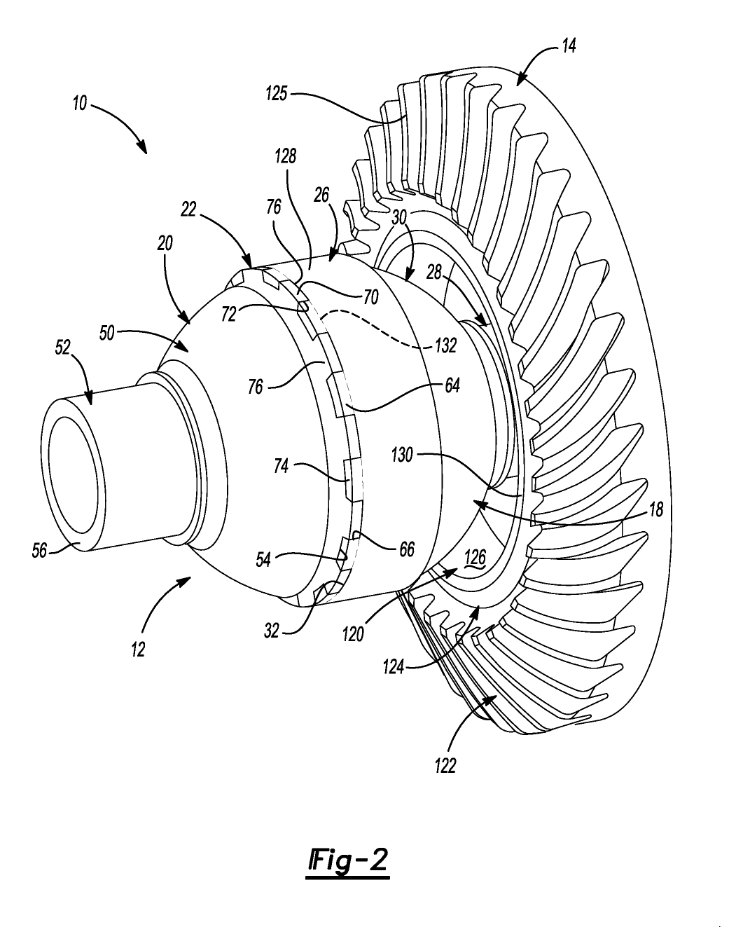

Ring gear 14 is shown, in this non-limiting example, to include a cylindrical rim segment 120, a toothed gear segment 122, and a radial web segment 124 interconnecting rim segment 120 to gear segment 122. As is known, gear segment 122 of ring gear 16 includes gear teeth 125 configured to be meshed with a pinion gear (in an axle system) or a final drive gear (in a transaxle system) to transmit drive torque to differential case 12. Rim segment 120 has an inner surface 126 configured to be press-fit onto an outer surface 128 of first cylindrical segment 26 of first case member 18. Rim segment 120 further includes a planar edge or face surface 130 defining a ring gear weldment surface. Ring gear weldment surface 130 is adapted to be aligned with a differential case weldment surface, shown best in FIG. 2 by dashed line 132. Following such alignment, a weld seam 134 of weld material is provided to rigidly connect ring gear 16 to each of case members 18, 20 while also rigidly connecting first case member 18 to second case member 20. While a single continuous weld seam 134 extending completely around the entire periphery of the weldment junction is preferred, a series of intermittent weld seams along the weldment junction is also possible. As an alternative, a differential case weldment surface 132A, as again best shown in FIG. 2, can be established along terminal end surfaces 74 of fingers 64 and first face surfaces 76 of lugs 70. In either case, a single weldment junction is established for securely welding all three components to one another.

As will be understood, differential gearset 16 is initially assembled into differential case 12 and thereafter interlocking feature 22 is engaged to mechanically couple first and second case members 18 and 20. Following assembly of differential case 12, ring gear 16 is installed (i.e., press-fit) thereon and positioned for subsequent weld processing. It will also be understood that the specific number, location, and physical dimensions of the interdigitated locking elements associated with interlocking feature 22 can be varied from the non-limiting example shown to accommodate alternative configurations. The inventive concepts of the present disclosure provide an arrangement for establishing a continuous weldment junction allowing the three components to be welded to one another. Case members 18 and 20 can be formed via stamping, net forging, spin forging, cold forming or any other suitable forming technologies currently available for manufacturing differential case components.

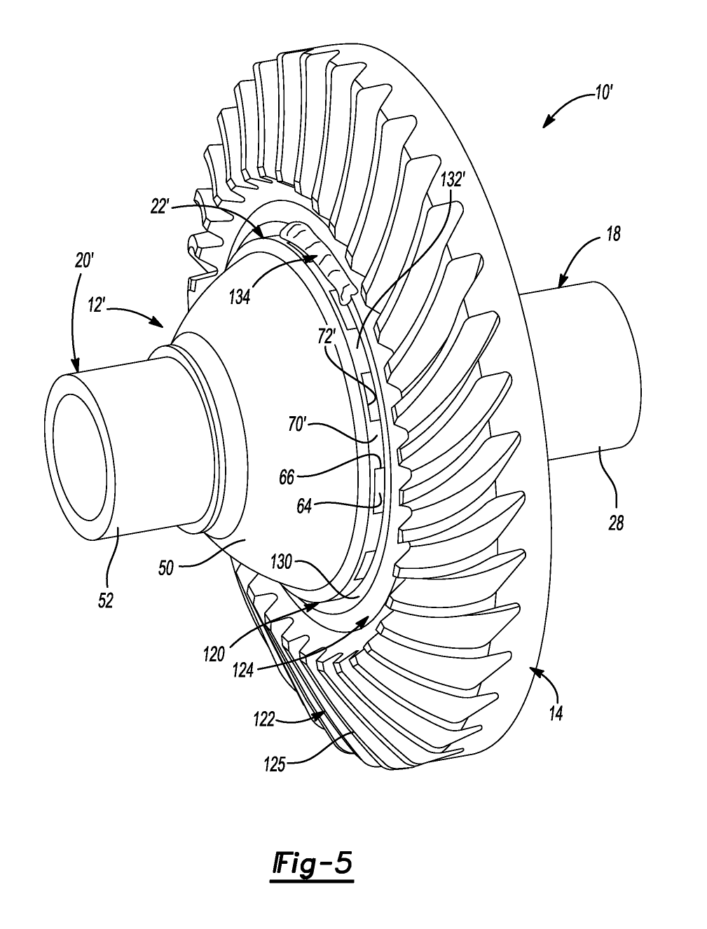

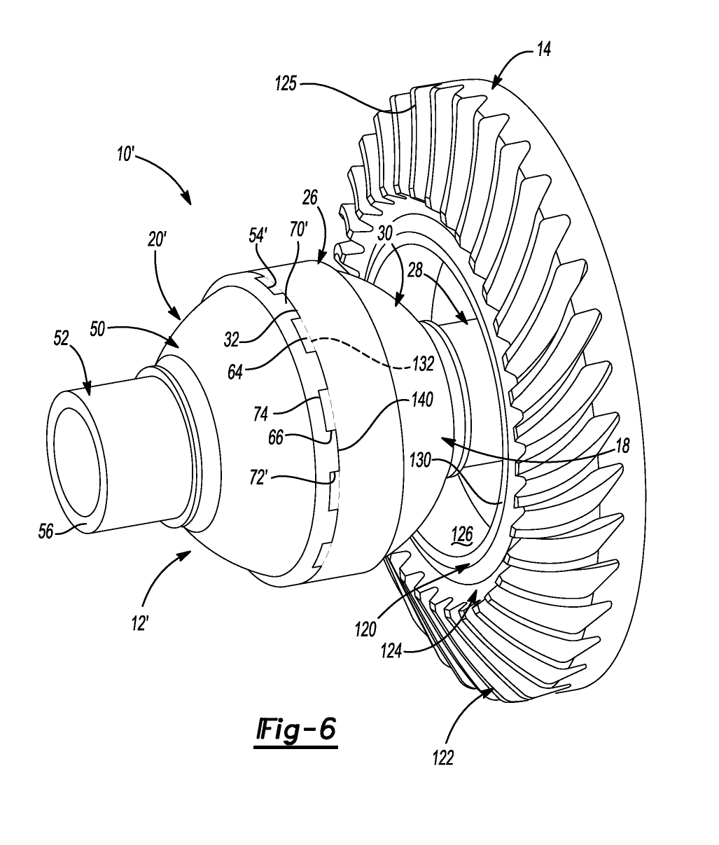

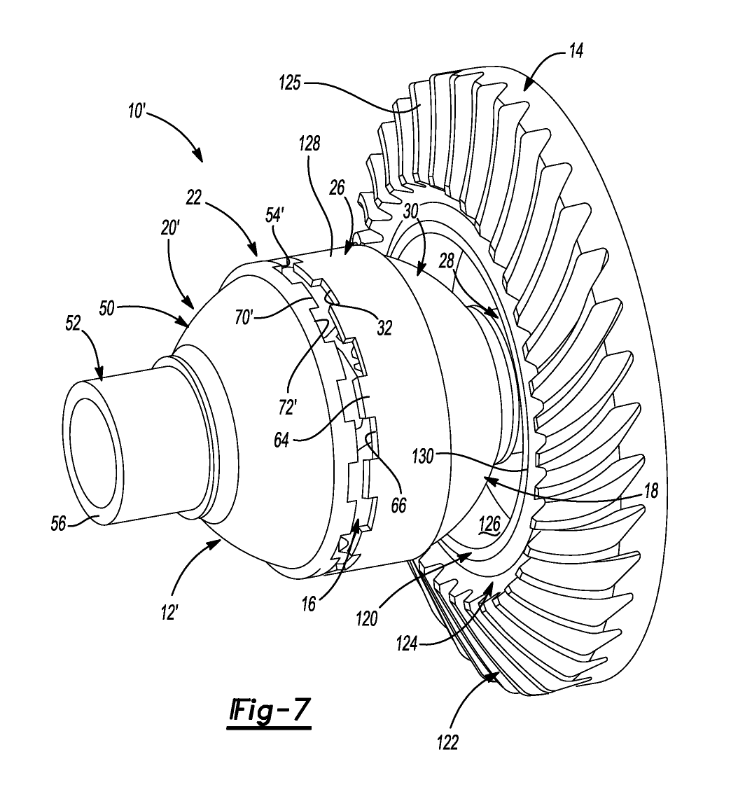

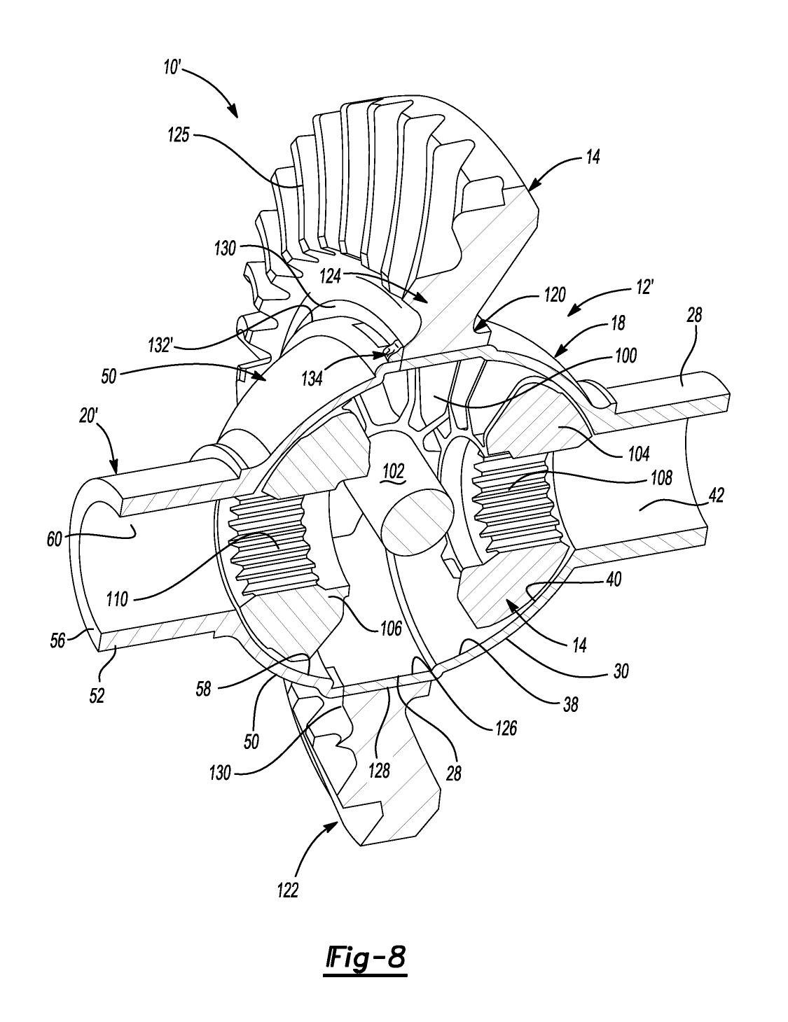

Turning now to FIGS. 5-8 of the drawings, a second embodiment of a differential assembly 10′ constructed in accordance with the present disclosure is also generally shown to include a two-piece differential case 12′, ring gear 14 and differential gearset 16. Due to the similarity of differential assembly 10′ to differential assembly 10 of FIGS. 1-4, common reference numerals are used to identify common components while “primed” reference numerals designate those components that have been altered or modified, particularly in association with interlocking feature 22′.

Two-piece differential case 12′ includes first case member 18 and a second case member 20′ that has been slightly modified in comparison to second case member 20 to accommodate the alternative configuration associated with interlocking feature 22′. Second case member 20′ is still configured to include semi-spherical segment 50 and tubular segment 52 which again define second side gear chamber 58 and second axleshaft chamber 60, respectively. However, instead of having lugs 70 extending radially from first open end surface 54, second case member 20′ now includes a plurality of axially-extending and circumferentially-spaced second locking elements or lugs 70′ extending outwardly from end surface 54′. Additionally, a plurality of second retention apertures or pockets 72′ are formed between adjacent axial lugs 70′. Thus, interlocking feature 22′ is configured to include a series of axial fingers 64 extending from first case member 18 that are adapted for retention in pockets 72′ formed in second case member 20′ and a series of axial lugs 70′ extending from second case member 20′ that are adapted for retention in slots 66 formed in first case member 18. In a preferred, but non-limiting embodiment of interlocking feature 22′, terminal end surfaces 74 of fingers 64 are configured to engage end surface 54′ of second case member 20′ while terminal end surfaces 140 of lugs 70′ are configured to engage end surface 32 of first case member 18. Additionally, the arcuate profile of axial fingers 64 and axial lugs 70′ define a continuous cylindrical mechanical interconnection area between first case member 18 and second case member 20′. Line 132′ identifies a differential case weldment surface established by two-piece differential case 12′.

Similar to that previously described, following assembly of differential gearset 16 into two-piece differential case 12′, ring gear 16 is pressed onto outer surface 128 of first cylindrical segment 26 on first case member 18 until ring gear weldment surface 130 of rim segment 120 on ring gear 16 is aligned with differential case weldment surface 132′. Thereafter, a weld seam 134 of weld material is provided therebetween to establish the single and continuous weldment junction and interconnect the three components to one another.

As previously mentioned, being able to secure first and second case members 18 and 20, 20′ and ring gear 16 to one another by one continuous weld seam along the weldment junction provides for a number of advantages. Among these include reduced fabrication costs since minimal time is needed by fabricators and few tools are required to perform the welding operation. Further, material costs are reduced since the fastening components (i.e., bolts) used to secure prior art differential assemblies are not required. Additionally, since the weld seam takes up minimal space, differential assembly 10, 10′ has a reduced packaging volume and mass. Furthermore, because of the simple design of the overall assembly, differential case members 18 and 20, 20′ may be metal components formed of high strength steels using the latest stamping, net forging or spin forming processes, therefore providing increased strength of the differential assembly.

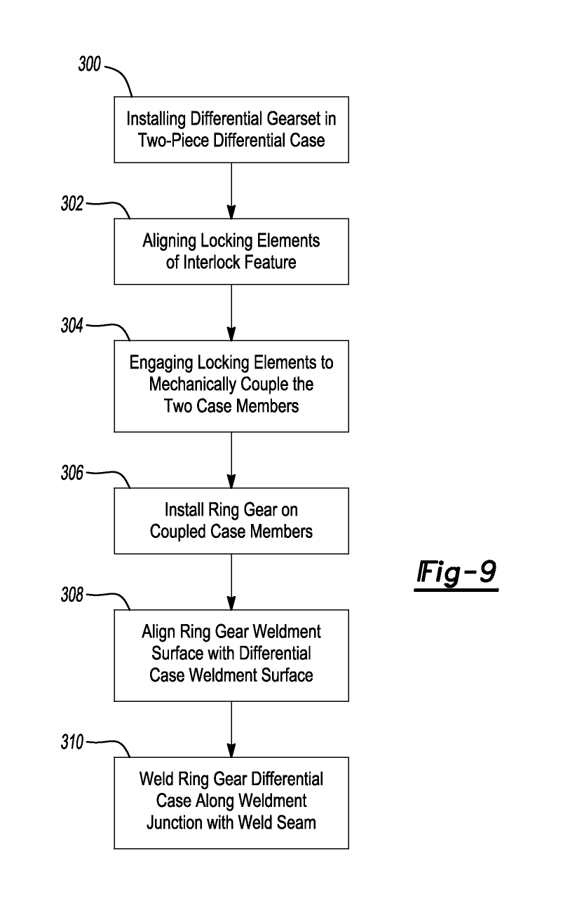

FIG. 9 diagrammatically illustrates a series of operations or step associated with a method for assembling differential assembly 10, 10′. The method includes a first step 300 for installing the components of differential gearset 16 in corresponding chamber portions of the first and second case members of two-piece differential case 12, 12′. The second step 302 includes aligning first locking elements 64 with second retention apertures 72, 72′ and aligning second locking elements 70, 70′ with first retention apertures 66. The third step 304 includes axially moving first case member 18 relative to second case member 20, 20′ to interdigitate locking elements 64 and 70, 70′ of interlocking feature 22, 22′ so as to mechanically interconnect the first and second case members. Thereafter, at fourth step 306, ring gear 16 is slid on (i.e., press-fit) cylindrical segment 26 of first case member 18. Next, step 308 indicates axially moving ring gear 16 until differential case weldment surface 132, 132′ is aligned with ring gear weldment surface 130 to define a single weldment junction alignment. Finally, step 310 indicates the process of welding ring gear 16 to differential case 12, 12′ along the weldment junction to fixedly connect ring gear 16, first case member 18, and second case member 20, 20′ to each other.

It should be appreciated that any type of welding method could be utilized along the weldment junction such as, but not limited to, laser, electronic beam, MIG (Metal in Gas) and TIG (Tungsten Inert Gas) welding. Other methods of fixedly connecting components could be used, e.g., brazing, soldering or high-strength adhesives. It should further be appreciated that the concepts described herein could be applied to open or closed style differential assemblies. Finally, it should also be pointed out that the specific configurations provided for the first and second case members of the differential cases disclosed herein are merely intended to be examples and any alternative configuration providing a mechanical interconnect and a pair of weldment surfaces alignable along a weldment junction are within the scope of the present disclosure.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varies in many ways. Such variations are not to be regarded as a departure from the disclosure, and all such modifications are intended to be included within the scope of disclosure.

What is claimed is:

1. A differential assembly, comprising:
a differential case including a first case member and a second case member together defining an internal gearset chamber, said first case member having a plurality of circumferentially-spaced first locking elements, said second case member having a plurality of circumferentially-spaced second locking elements adapted to interlock with said first locking elements to mechanically couple said first and second case members and establish a common differential case weldment surface;
a differential gearset disposed within said gearset chamber of said differential case; and
a ring gear configured to surround an outer surface of at least one of said first and second case members and define a ring gear weldment surface adapted to be aligned with said differential case weldment surface and establish a weldment junction therebetween;
wherein said ring gear is welded to said differential case by a weld seam located at said weldment junction such that said weld seam connects said ring gear to each of said first and second case members and also connects said first case member to said second case member.

2. The differential assembly of claim 1 wherein said first locking elements are configured as axially-extending fingers, and wherein said first case member includes a plurality of first retention apertures each being formed between a pair of adjacent axial fingers.

3. The differential assembly of claim 2 wherein said second locking elements are configured as radially-extending lugs, and wherein said second case member includes a plurality of second retention apertures each being formed between a pair of adjacent radial lugs.

4. The differential assembly of claim 3 wherein said axially-extending fingers on said first case member are configured for retention in said second retention apertures formed in said second case member, and wherein said radially-extending lugs on said second case member are configured for retention in said first retention apertures formed in said first case member so as to define a mechanical interlocking feature.

5. The differential assembly of claim 4 wherein said axially-extending fingers and said radially-extending lugs having a matching arcuate contour defining a cylindrical segment of interdigitation between said first and second locking elements for establishing said differential case weldment surface, wherein said ring gear has a cylindrical rim segment disposed on a cylindrical segment of said first case member and which has a face surface defining said ring gear weldment surface, and wherein said ring gear weldment surface on said rim segment of said ring gear is coaxially aligned with said differential case weldment surface defined by said cylindrical segment of interdigitated locking elements so as to establish said weldment junction.

6. The differential assembly of claim 2 wherein said second locking elements are configured as axially-extending lugs, and wherein said second case member includes a plurality of second retention apertures each being formed between a pair of adjacent axial lugs.

7. The differential assembly of claim 6 wherein said axially-extending fingers on said first case member are configured for retention in said second retention apertures of said second case member, and wherein said axially-extending lugs on said second case member are configured for retention in said first retention apertures formed in said first case member so as to define an interlocking feature.

8. The differential assembly of claim 7 wherein said axially-extending fingers and said axially-extending lugs having a matching arcuate contour defining a cylindrical segment of interdigitation between said first and second locking elements for establishing said differential case weldment surface, wherein said ring gear has a cylindrical rim segment disposed on a cylindrical segment of said first case member and which has a face surface defining said ring gear weldment surface, and wherein said ring gear weldment surface on said rim segment of said ring gear is coaxially aligned with said differential case weldment surface defined by said cylindrical segment of interdigitated locking elements so as to establish said weldment junction.

9. The differential assembly of claim 1 wherein said plurality of first locking elements extend from an end surface of said first case member, wherein said plurality of second locking elements extend from an end surface of said second case member, and wherein said end surface of said first case member is aligned in close proximity to said end surface of said second case member when said first and second locking elements are interdigitated.

10. A differential assembly, comprising:
a differential case including a first case member, a second case member, and an interlocking arrangement for mechanically connecting said first and second case members, said interlocking arrangement including a plurality of first locking elements extending from said first case member, a plurality of first retention apertures formed between adjacent first locking elements, a plurality of second locking elements extending from said second case member, and a plurality of second retention apertures formed between adjacent second locking elements, said first locking elements being configured to be retained in said second retention apertures and said second locking elements being configured to be retained in said first retention apertures so as to establish a differential case weldment surface; and
a ring gear configured to surround an outer surface of at least one of said first and second case members and define a ring gear weldment surface adapted to be aligned with said differential case weldment surface;
wherein said ring gear is welded to said differential case by a weld seam located in a weldment junction defined between said differential case weldment surface and said ring gear weldment surface such that said weld seam connects said ring gear to each of said first and second case members and also connects said first case member to said second case member.

11. The differential assembly of claim 10 wherein said first locking elements are axially-extending fingers, and wherein said second locking elements are radially-extending lugs.

12. The differential assembly of claim 11 wherein said axially-extending fingers on said first case member are configured for retention in said second retention apertures formed in said second case member, and wherein said radially-extending lugs on said second case member are configured for retention in said first retention apertures formed in said first case member so as to define a mechanical interlocking feature.

13. The differential assembly of claim 12 wherein said axially-extending fingers and said radially-extending lugs having a matching arcuate contour defining a cylindrical segment of interdigitation between said first and second locking elements for establishing said differential case weldment surface, wherein said ring gear has a cylindrical rim segment disposed on a cylindrical segment of said first case member and which has a face surface defining said ring gear weldment surface, and wherein said ringer gear weldment surface on said rim segment of said ring gear is coaxially aligned with said differential case weldment surface defined by said cylindrical segment of interdigitated locking elements so as to establish said weldment junction.

14. The differential assembly of claim 10 wherein said first locking elements are axially-extending fingers, and wherein said second locking elements are axially-extending lugs.

15. The differential assembly of claim 14 wherein said axially-extending fingers on said first case member are configured for retention in said second retention apertures of said second case member, and wherein said axially-extending lugs on said second case member are configured for retention in said first retention apertures formed in said first case member so as to define an interlocking feature.

16. The differential assembly of claim 15 wherein said axially-extending fingers and said axially-extending lugs having a matching arcuate contour defining a cylindrical segment of interdigitation between said first and second locking elements for establishing said differential case weldment surface, wherein said ring gear has a cylindrical rim segment disposed on a cylindrical segment of said first case member and which has a face surface defining said ring gear weldment surface, and wherein said ring gear weldment surface on said rim segment of said ring gear is coaxially aligned with said differential case weldment surface defined by said cylindrical segment of interdigitated locking elements so as to establish said weldment junction.

17. The differential assembly of claim 10 wherein said plurality of first locking elements extend from an end surface of said first case member, wherein said plurality of second locking elements extend from an end surface of said second case member, and wherein said end surface of said first case member is aligned in close proximity to said end surface of said second case member when said first and second locking elements are interdigitated.

18. A differential assembly, comprising:
a differential case including a first case member and a second case member, said first case member having a plurality of first locking elements interdigitated with a plurality of second locking elements associated with said second case member to establish a mechanical interconnect therebetween and define a differential case weldment surface; and
a ring gear having a rim segment and a toothed gear segment, said rim segment surrounding at least one of said first and second case members and defining a ring gear weldment surface alignable with said differential case weldment surface to establish a weldment junction therebetween, wherein said ring gear is welded to said differential case along said weldment junction so as to weld said ring gear to each of said first and second case members.

19. The differential assembly of claim 18 wherein said first locking elements are axially-extending fingers and which define a plurality of first retention apertures therebetween, and wherein said second locking elements are radially-extending lugs sized to be retained in said first retention apertures, said lugs defining a plurality of second retention apertures therebetween sized to retain said fingers therein.

20. The differential assembly of claim 18 wherein said first locking elements are axially-extending fingers which are separated by first retention apertures, wherein said second locking elements are axially-extending lugs which are separated by second retention apertures, and wherein said fingers are configured to be retained within said second retention apertures and said lugs are configured to be retained within said first retention apertures.
